(19) United States
(12) Patent Application Publication
(10) Pub. No.: US 2006/0123339 A1
(43) Pub. Date: Jun. 8, 2006

(54) General purpose user interface system and method

(76) Inventors: Carmen DiMichele, Sparks, NV (US); James W. Morrow, Sparks, NV (US); Michael M. LeStrange, Reno, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/227,002

(22) Filed: Sep. 14, 2005

Related U.S. Application Data
(63) Continuation-in-part of application No. 10/943,771, filed on Sep. 16, 2004.

(51) Int. Cl. G06F 3/00

(52) U.S. Cl. 715/700

(57) ABSTRACT

A general purpose additional user interface for enhancing user interaction with a native system is disclosed. The additional user interface includes a display, a memory and a processor. A plurality of output data files are stored in the memory. A connection capable of receiving context data from the native system is provided. The processor reads the context data received from the native system, and matches the context data with one or more of the output data files for presentation on the display. An audio device is provided for presenting output data files that are sound files.

### CROSS REFERENCE TO RELATED DOCUMENTS

This application is a continuation-in-part of U.S. patent application Ser. No. 10/943,771 filed Sep. 16, 2004.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates generally to a general purpose user interface for incorporation with a native system, and more particularly, to a system and methodology that integrates an additional user interface having a display screen and/or sound system with the native system for enhanced output and input.

### BACKGROUND OF THE INVENTION

Traditionally, gaming machines have been designed for gaming purposes only. In this regard, gaming machines have been constructed only to include gaming functionality. Recently, however, casino owners have become aware that by adding additional features to gaming machines, they may be able to maintain a player's attention to the gaming machines for longer periods of time. This, in turn, leads to the player wagering at the gaming machine for longer periods of time, thereby increasing casino profits.

One technique that has been employed to maintain a player's attention at the gaming machine has been to provide players with access to gambling-related information. By attaching a small electronic display to the gaming device, gambling-related information, as well as news and advertisements can be sent to the player. The gambling-related information may include, for example, information on sports betting and betting options for those sporting events. Additionally, the gambling-related information may also include information such as horse racing and off-track betting. News and advertisements can also maintain a player's attention by providing the player with access to information ranging from show times, to restaurant and hotel specials, and to world events, thus reducing the need and/or desire for the player to leave the gaming machine.

Moreover, it would be desirable to provide the player with interactive access to the above information. This type of interactivity would allow players significantly more flexibility to make use of the above-described information. The gambling-related information could also be utilized by the player in a much more efficient manner. In this regard, greater levels of flexibility and access are likely to make a player remain and gamble at the gaming machine for significantly longer periods of time. Unfortunately, the system components that are currently utilized for displaying and accessing this type of information, such as external keypads and display modules, are extremely limited in the functionality and capabilities that they provide, thus limiting the success of their ability to maintain a player's attention.

As stated above, attempts to distribute gambling-related information and advertisements to players, has typically required additional system components to be attached to the gaming devices separately and apart from the construction of the gaming machine itself. Specifically, these components for accessing and displaying information from gaming machines have been extremely limited in their usefulness because of the lack of capabilities inherent in these components. Such components have generally included a keypad, card reader, and display equipment, such as a 2-line LED display. It would be desirable for these components to be integrated into the gaming device itself, in a more unified fashion to provide substantially greater functionality than that which has been previously available.

Accordingly, those skilled in the art have long recognized the need for a system that is capable of integrating expanded service and systems capabilities with the more traditional function of a gaming device or other type of native system. The claimed invention clearly addresses these and other needs.

### SUMMARY OF THE INVENTION

Briefly, and in general terms, the claimed invention resolves the above and other problems by providing an embedded additional user interface for use in a gaming machine, wherein the gaming machine includes a gaming screen and a gaming processor. More particularly, the embedded additional user interface includes a web content capable display screen and an embedded processor. Preferably, the web content capable display screen presents web information to a user via the display screen. The embedded processor preferably utilizes an internal operating system and communicates with the gaming processor. Preferably, the embedded processor reads incoming data, translates the data into a web protocol (web authoring language), if necessary, and maps the data to the web content capable display screen. In this manner, the web content capable display screen increases user excitement by providing a richer gaming experience.

In accordance with another aspect of a preferred embodiment, the incoming data received by the embedded additional user interface are I²C messages (or other serial communications). Preferably, the embedded processor communicates with the gaming processor, and/or other connected devices, over an I²C bus (or other serial communications bus). The web content capable display screen of the embedded additional user interface is preferably a color graphic touch screen display. Preferably, the embedded processor is at least a 32-bit processor. Further, the internal operating system of an embedded additional user interface is preferably customized to match the specific hardware to which the internal operating system attaches.

In accordance with another aspect of a preferred embodiment, the embedded processor utilizes cryptographic technology. In one preferred embodiment, a certification process is offered for authentication and non-repudiation of the web content. Preferably, the certification process provides audit-ability and traceability. Specifically, the certification process provides sufficient security for gaming regulators to allow casino operators to design their own content.

In accordance with another aspect of a preferred embodiment, HTML is the web protocol into which the incoming data is translated in the embedded additional user interface. In another preferred embodiment, DHTML is the web protocol into which the incoming data is translated in the embedded additional user interface. In still another preferred embodiment, XML is the web protocol into which the incoming data is translated in the embedded additional user interface. In yet another preferred embodiment, MACROMEDIA FLASH animation technology is the web protocol into which the incoming data is translated in the embedded additional user interface. In one preferred embodiment, the embedded additional user interface connects to an Ethernet-networked backbone. Further, in one preferred embodiment, the embedded additional user interface connects to a web server through an Ethernet-networked backbone.

In another preferred embodiment, the embedded additional user interface includes an animation capable display screen and an embedded processor. In yet another preferred embodiment, the embedded additional user interface includes a web page display screen and an embedded processor. In still another preferred embodiment, the embedded additional user interface includes a multimedia display screen and an embedded processor.

In accordance with another preferred embodiment, the claimed invention is directed towards an embedded additional user interface that is incorporated into a gaming machine that includes a separate gaming screen (or gaming region, e.g., spinning reels). The embedded additional user interface includes a web content capable display screen and an embedded processor. Preferably, the web content capable display screen presents web information to a user via the display screen. The embedded processor preferably utilizes an internal operating system. The embedded processor reads incoming data, translates the data into a web protocol (web authoring language), if necessary, and maps the data to the web content capable display screen. Furthermore, in this embodiment the embedded processor additionally includes standard gaming processor functionality, and as such, replaces the standard gaming processor in the gaming machine.

In accordance with another preferred embodiment, the claimed invention is directed towards a gaming machine that includes an embedded additional user interface having a web page display screen. Preferably, the gaming machine includes a gaming display screen, a gaming processor, and an embedded additional user interface. The embedded additional user interface further includes the same web page display screen and an embedded processor that has been described above.

In accordance with another preferred embodiment, the claimed invention is directed towards a method for increasing user excitement relating to a gaming machine by providing a richer gaming experience via an embedded additional user interface that is incorporated into the gaming machine. Preferably, the embedded additional user interface includes an embedded processor and a web page display screen. The method preferably includes: receiving a serial data message containing enhanced player information over a serial communication bus (e.g., an I²C bus) in the embedded additional user interface; translating the data message into a web authoring language, if necessary; and mapping the data message to the web page display screen, wherein the display screen presents web page information to a user via the display screen.

In one embodiment, the web content is protected by digital signature verification using DSA (Digital Signature Algorithm) or RSA (Rivest-Shamir-Adleman) cryptographic technology. In this regard, the content is preferably protected using digital signature verification so that any unauthorized changes are easily identifiable. Of course, other suitable protection techniques may also be used in other embodiments.

Still further, one preferred embodiment utilizes a Message Authentication Code (MAC), which may be used to verify both the content integrity and the authenticity of a message. A Message Authentication Code can be generated faster than using digital signature verification technology, although it is not as robust. In one preferred embodiment, the authentication technique utilized is a BKEY (electronic key) device. A BKEY is an electronic identifier that is tied to a particular individual.

Typically, in a preferred embodiment, the data is authenticatible and non-repudiatible, rather than hidden or otherwise obfuscated, but may be obfuscated as the need anises. Non-repudiation is a way to guarantee that the sender of a message cannot later deny having sent the message, and that the recipient cannot deny having received the message.

In accordance with one preferred embodiment, one or more gaming machine system or embedded additional user interface components (or content) are assigned identification codes. The components are grouped together into a protected group of component bindings using cryptographic security procedures and the identification codes of the components in the bindings group. Accordingly, the bindings prevent falsification or repudiation of content entries with respect to any modifications or replacements of components or content within the bindings group.

In accordance with another aspect of a preferred embodiment, every content entry must be authenticated by being digitally signed with a Hashed Message Authorization Code that is based on the entry itself and on the individual identification codes of the components and content in the bindings group. In the same manner, every entry that attempts a replacement of any of the embedded additional user interface components or content must be authenticated by being digitally signed with a Hashed Message Authorization Code that is based on the entry itself and on the individual identification codes of the components and content in the bindings group.

Preferably, the identification codes of the embedded additional user interface components are randomly or pseudo-randomly generated. In accordance with another aspect of the verification system, a Hashed Message Authorization Code key for authenticating access to the component bindings is produced using a SHA-1 (or better, e.g., SHA-256, 512) hash that is generated using the individual identification codes of the components in the bindings group. Additionally, the embedded additional user interface components are secured within the component bindings using a SHA-1 (or better) hash that is generated using the individual identification codes of the components and content in the bindings group.

In accordance with another aspect of a preferred embodiment, a general purpose additional user interface for enhancing user interaction with a native system is provided. The additional user interface includes a display, a memory and a processor. A plurality of output data files are stored in the memory. A connection capable of receiving context data from the native system is provided. The processor reads the context data received from the native system, and matches the context data with one or more of the output data files for presentation on the display. An audio device is provided for presenting output data files that are sound files.

Other features and advantages of the claimed invention will become apparent from the following detailed description when taken in conjunction with the accompanying drawings, which illustrate by way of example, the features of the claimed invention.

### BRIEF DESCRIPTION OF THE DRAWINGS

FIG. 1 illustrates a relational diagram of an embedded additional user interface, constructed in accordance with the claimed invention, utilizing a web page display screen and an embedded processor that receives data messages from a game monitoring unit that are translated into web page content and mapped to the web page display screen;

FIG. 2 illustrates a relational diagram of a prior art gaming system that utilizes a 2×20 VF display and 12-digit keypad;

FIG. 3 illustrates a relational diagram of embedded additional user interface, constructed in accordance with the claimed invention, utilizing a web page display screen and an embedded processor that receives cryptographically certified web page content from a portable computer via a network adapter port;

FIG. 4 illustrates a relational diagram of embedded additional user interface, constructed in accordance with the claimed invention, utilizing a web page display screen and an embedded processor that receives web page content from a back-end server via an Ethernet-networked backbone;

FIG. 5 illustrates a relational diagram of embedded additional user interface, constructed in accordance with the claimed invention, utilizing a web page display screen and an embedded processor that includes the functionality of a standard gaming processor;

FIG. 6 illustrates an object interaction diagram of embedded additional user interface, constructed in accordance with the claimed invention;

FIG. 7 is a diagram showing the sequence of events that occur when data is sent between the embedded additional user interface and the game monitoring unit;

FIG. 8 is a diagram showing the sequence of events that occur when a virtual key is pressed on the web page display screen; and

FIG. 9 is a diagram showing components of a general purpose additional user interface that provides enhanced output and input for a native system in one embodiment of the invention.

### DETAILED DESCRIPTION OF THE PREFERRED EMBODIMENTS

A preferred embodiment of the embedded additional user interface, constructed in accordance with the claimed invention, is directed towards the integration of an embedded additional user interface into a gaming machine to increase user excitement by providing a richer gaming experience. The embedded additional user interface provides enhanced player satisfaction and excitement, as well as improved gaming device reliability, interactivity, flexibility, security, and accountability. The user interface is sometimes referred to herein as “additional” in that the user interface is separate from the gaming screen (or other gaming presentation). Further, the user interface is sometimes referred to herein as “embedded” in that the user interface includes its own processor in some preferred embodiments of the invention.

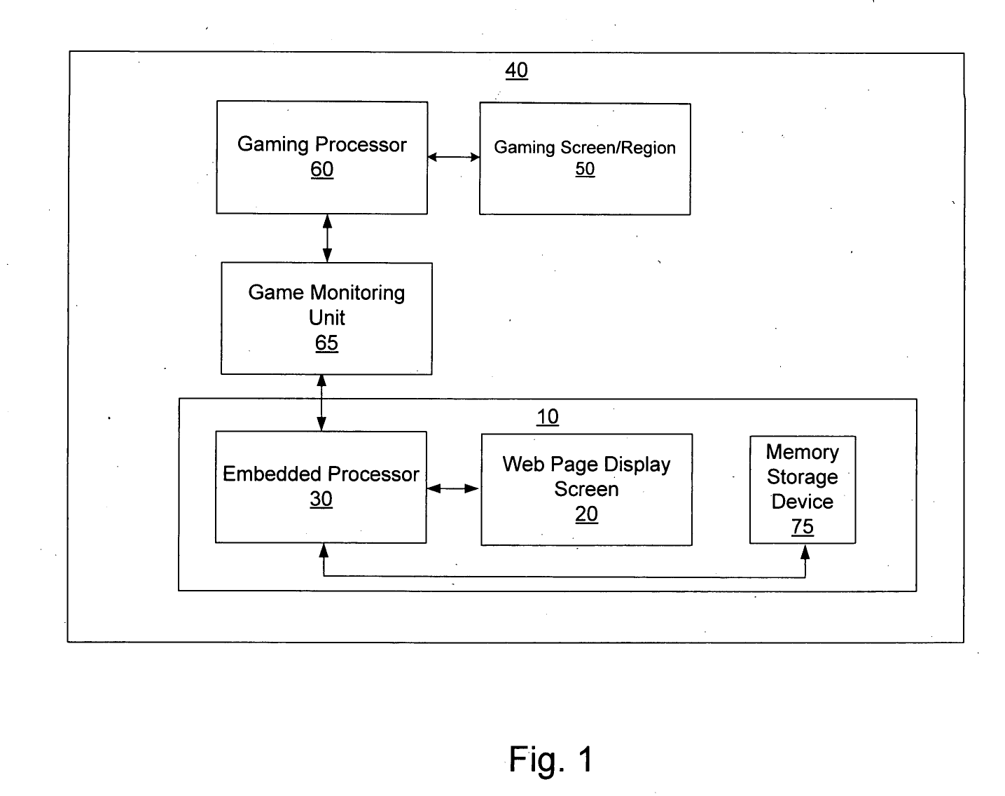

Referring now to the drawings, wherein like reference numerals denote like or corresponding parts throughout the drawings and, more particularly to FIGS. 1-5, there is shown one embodiment of an embedded additional user interface 10. Specifically, FIG. 1 shows an embedded additional user interface 10 that includes a web page display screen 20 and an embedded processor 30. The user interface 10 is incorporated into a gaming machine 40 that, in turn, includes a gaming screen 50, (and/or non-screen gaming region 50, e.g., spinning reels or other gaming presentation) gaming processor 60, and a game monitoring unit 65. The embedded processor 30 employs an internal operating system and communicates with the gaming processor 60, preferably via the game monitoring unit 65. The embedded processor 30 reads incoming data, translates the data into a web authoring language, and maps the data to the web page display screen 20. The display screen 20 presents web page information to a user via the display screen, thereby increasing user excitement by providing a richer gaming experience. The game monitoring unit 65 monitors the information that is input through the user interface 10. This provides a dramatic improvement over traditional system components 70 that have been used as in the past to provide user information. The user interface 10 communicates with the game monitoring unit 65 in the same manner as the previous system components 70 communicated with the game monitoring unit.

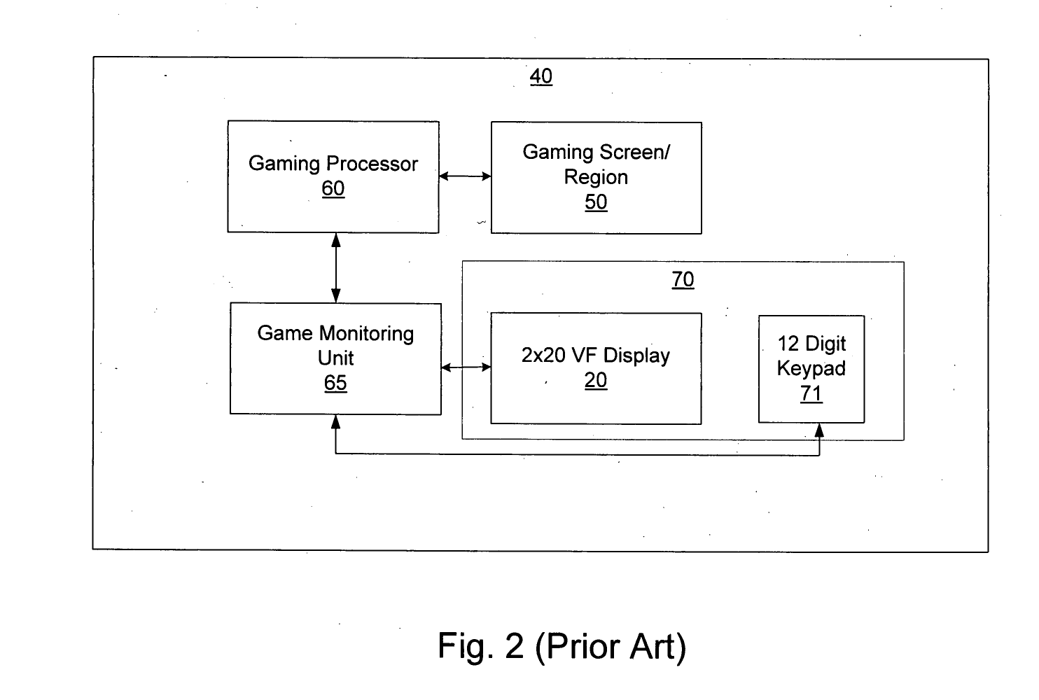

As shown in FIG. 2, prior art gaming devices typically utilized a single video display screen as a gaming screen 50 for the gaming machine 40, while additional system components 70 were attached or juxtaposed next to the gaming machine. The display may comprise, for example, a 2-line, 20 character VF (Vacuum Fluorescent) display 20. An input device may comprise a 12-digit keypad 71.

However, referring again to FIG. 1, in a preferred embodiment of the claimed invention, the system components 70 that were used in prior art systems are replaced with the embedded additional user interface 10 to provide the advanced functionality of a web page display screen 20. Such functionality includes, by way of example only, and not by way of limitation, the ability to display animation, multimedia, and other web-type content. The embedded additional user interface 10 enables presentation of additional information (e.g., enhanced player information) to a player (or potential player) through the web page display screen 20 in an exciting, eye-catching format, while not interfering with the normal gaming processes being displayed on the gaming screen 50. Further, the embedded additional user interface 10 does not interfere with the normal gaming hardware in the gaming machine 40, but rather is easily integrated into a gaming machine 40.

In situations involving multiple gaming machine (or gaming component) manufacturers, an embedded additional user interface 10 can be incorporated into a gaming machine (either originally or by retrofitting) without requiring access to the game logic or other gaming systems that might be proprietary and inaccessible with a gaming machine from another gaming manufacturer. Thus, in a preferred embodiment of the claimed invention, the embedded additional user interface 10, which includes a web page display screen 20 for presenting supplementary information to a player, is incorporated into a gaming machine 40 in addition to the standard gaming screen 50 typically found in a gaming machine. The embedded additional user interface 10 may also be incorporated into a gaming machine 40 that utilizes a gaming region (e.g., a reel-spinner) instead of a standard gaming screen 50. This supplemental information may include general gaming information, player specific information, player excitement and interest captivation content, advertising content (targeted or otherwise), and the like. Further, in other preferred embodiments, the embedded additional user interface 10 may have the ability to interact with the game logic of the gaming processor 60, preferably via the game monitoring unit 65, and thus, provide further functionality, such as bonus games, system games, and/or the ability to incorporate awards, promotional offers, or gifts from the web page display screen 20 to the gaming screen 50. Moreover, the web page display screen 20 may display supplemental information in an “attract mode” when there is no game play occurring. Also the gaming processor 60 may use the web page display screen 20 to present casino employees with a web based dialogue to facilitate gaming machine configuration and event investigation activities without disturbing the gaming screen/region 50.

In a preferred embodiment of the claimed invention, the embedded additional user interface 10 is used to make casino services more accessible and friendly to casino patrons. In one preferred embodiment, the embedded additional user interface 10 is designed to interface with the hardware configuration of game platforms currently employed in an existing gaming communication systems network, thus decreasing implementation costs for the casino. A standard gaming network interface to the systems network, such as a Mastercom system, includes a multi-drop bus method of communicating to a keypad and display. The Mastercom system is available from Bally Manufacturing, and is described in U.S. Pat. No. 5,429,361 to Raven et al. incorporated herein by reference. One such currently utilized bus is an EPI (Enhanced Player Interface), which uses an industry standard I²C bus and signaling.

In one preferred embodiment, the embedded additional user interface 10 is used to replace/upgrade an EPI. Preferably, the embedded additional user interface 10 replaces the EPI of the gaming machine in a “plug and play” manner. In other words, the old EPI can be unplugged and the new embedded additional user interface 10 can simply be plugged into the I²C bus of the game monitoring unit 65 in the gamming machine 40. The user interface 10 utilizes the currently employed industry standard I²C bus and signaling without requiring any further modification. The embedded processor 30 of the embedded additional user interface 10 reads incoming I²C data (content), translates the data into a web authoring language (e.g., HTML, DHTML, XML, MACROMEDIA FLASH), and maps the data to the web page display screen 20. In this manner, the previous I²C data messages, which were typically presented on a 2-line, 20 character VF display, are automatically transformed by the embedded additional user interface 10 into an attention grabbing, animated (multimedia) web page style format. This results in enhanced player satisfaction and excitement with extremely minimal retrofitting requirements.

Since, in one preferred embodiment, the embedded additional user interface 10 utilizes I²C hardware and signaling, this enables the user interface 10 to speak and understand the I²C protocol message set, and thus, communicate directly with the gaming processor 60 of the gaming machine 40 (or other similarly networked devices) in the same fashion in which the gaming processor previously communicated with the EPI. Accordingly, in a preferred embodiment of the claimed invention, the functionality of the previously utilized hardware (e.g., the EPI) can be replaced or augmented and thus substantially upgraded with the integration of the embedded additional user interface 10 into the gaming machine 40. As such, the limitations placed upon the gaming processor 50 by the low function external hardware of such system components 70 (e.g., a keypad and a 2-line, 20 character VF display) may be eliminated.

As stated above, in one preferred embodiment, the incoming data received by the embedded additional user interface 10 is I²C signaling protocol; however, in other preferred embodiments other serial communication protocols (or electronic communication format) may be utilized. Preferably, the embedded processor 30 communicates with the gaming processor 60 via the game monitoring unit 65, and/or other connected devices, over an I²C bus (or over another serial communications bus in embodiments that utilize another protocol). The web page display screen 20 of the embedded additional user interface 10 is preferably a color-graphic touch screen display. Preferably, the embedded processor 30 is at least a 32-bit processor. A preferred embodiment utilizes a 32-bit processor because cryptographic techniques, such as SHA-1 (or better) and DSA algorithms, are written and operate natively on a 32-bit system. Additionally, the Microsoft® Windows® environment, which is utilized in some preferred embodiments of the claimed invention, is also 32-bit. Further, in one embodiment the internal operating system of the embedded additional user interface 10 is customized to match the specific communication bus hardware used by the devices in the gaming machine 40 to which the internal operating system communicates.

Preferably, the embedded additional user interface 10 is an embedded computer board that, in addition to the embedded processor 30 and the web page display screen 20, further includes a removable COMPACT FLASH card 75 (or other memory storage device), as shown in FIG. 1, and a network adapter port. Content and feature updates to the embedded additional user interface 10 are accomplished by physically swapping out the COMPACT FLASH card 75 (or other memory storage device). Thus, in order to retrieve data from the embedded additional user interface 10, the data is accessed by physically removing and reading the COMPACT FLASH card 75. In other embodiments, as described below, updates may be provided by direct or peer-to-peer downloading over a network.

In one preferred embodiment, the internal operating system utilized by the embedded processor 30 of the embedded additional user interface 10 is WINDOWS® CE version 4.2 (or higher). Preferably, the embedded additional user interface 10 is built upon a PXA255-based board developed by the Kontron Corporation. Additionally, in a preferred embodiment of the embedded additional user interface 10, the browser control for the web page display screen 20 is MICROSOFT® INTERNET EXPLORER® 6.0 (or higher), which is shipped standard with WINDOWS® CE 4.2, the preferred internal operating system for the embedded processor 30.

A preferred embodiment of the embedded additional user interface 10 also provides a mechanism for inputting system information into, and retrieving system information from, the game machine 40. As stated above, the embedded additional user interface 10 preferably uses industry standard I²C hardware and signaling. The I²C protocol has multi-master capabilities, i.e., is capable of participating as both a slave and as a master. The embedded additional user interface 10 enables system information (such as information input by a player into a web page display screen 20) to be sent from the game machine 40 to a slot system network (or to another destination location). Likewise, the embedded additional user interface 10 also enables the system information (such as display messages) to be sent from the systems network (or from another source location) to the game machine 40 for viewing by the player through the web page display screen 20.

In a preferred embodiment, information can also be input by a user into the web page display screen 20 of the user interface 10. The web page display screen 20 of the user interface 10 employs a virtual keypad. Further, the user interface 10 uses a keypad dictionary that allows a user to be able to enter a vastly greater amount of information than was previously possible using a 12 digit VF keypad. For example, the virtual key on the touch screen that is displayed by the browser is pressed by a user. This calls the Keypad object by calling its Dispatch interface with a string that identifies which virtual key was pressed. The Keypad object looks up the string in the Dictionary object which has been loaded at initialization time with a set of keys to return when that string is passed to it. When it retrieves this set of zero or more key characters, it passes them to the GMU by calling the interface exposed by the object.

Typically, a network interface (or equivalent system) is used to control the flow of funds used with the gaming machine 40 within a particular casino. By utilizing the embedded additional user interface 10 of the claimed invention, the gaming network interface can be instructed to move funds between player's accounts and gaming devices by merely touching the web page display screen 20. In addition, many other more sophisticated commands and instructions may be provided. Thus, the embedded additional user interface 10 improves the player and casino employee interface to the gaming machine 40, directly at the gaming device itself.

In a preferred embodiment of the claimed invention, the web page display screen 20 of the embedded additional user interface 10 enables a player to be shown player messages in an animated, multimedia, web content style environment. These messages would previously have been displayed in a significantly more mundane format on a separate display device (e.g., a 2-line VF display device). In some preferred embodiments, touch screen buttons in the web page display screen 20 are used by the player to navigate between windows in web page display screen 20 and allow access to system functions such as cashless withdraw, balance requests, system requests, points redemption, and the like. In other preferred embodiments of the claimed invention, the web page display screen 20 utilizes various other data input techniques commonly known in the art, instead of the touch screen data entry. Thus, implementation of the embedded additional user interface 10 is an efficient, highly beneficial, and substantial upgrade to a gaming machine 40 that greatly increases the functionality over what was previously possible using an EPI.

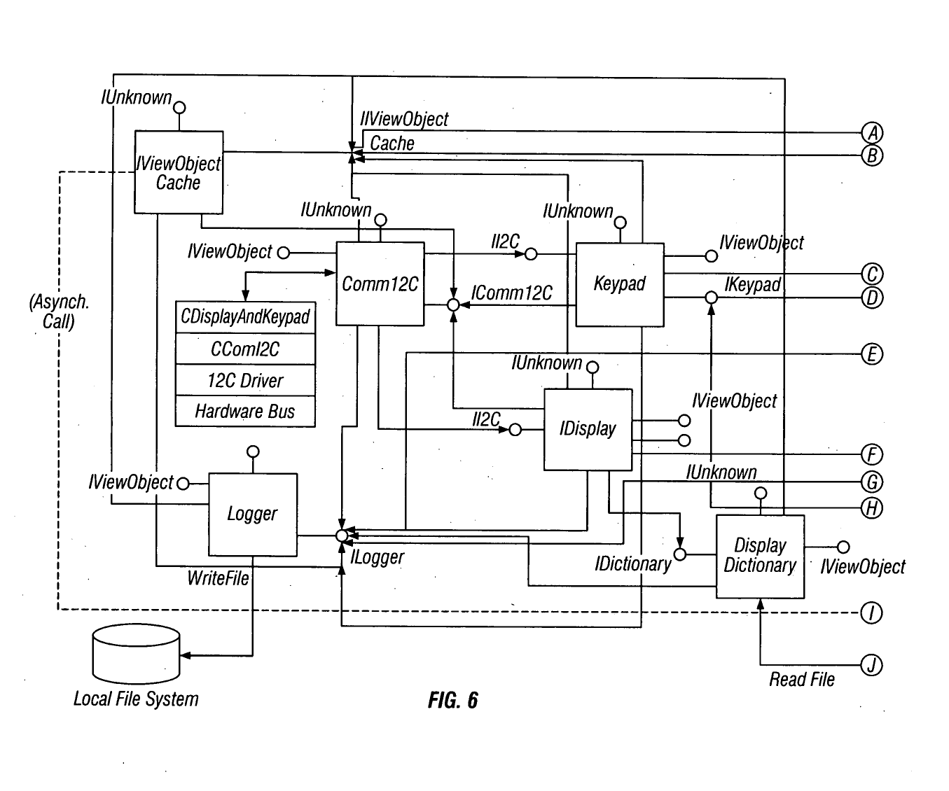

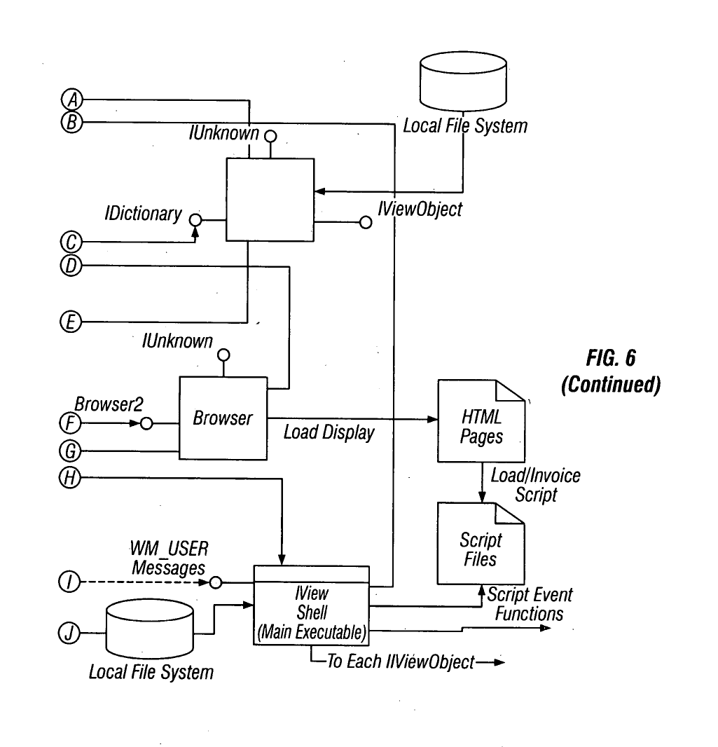

In one preferred embodiment, text data messages are translated into web page navigation requests by the embedded processor 30 and then displayed on the web page display screen 20 as shown and discussed with respect to FIGS. 6A and 6B below. Script languages, such as JAVA SCRIPT and VB SCRIPT, are also utilized for some of the web pages. Preferably, the embedded additional user interface 10 emulates the 12-digit keypad and the 2×20 VF display on the web page display screen 20, which has touch screen capabilities. In this embodiment, commands that were previously displayed on the 2×20 VF display are matched to a corresponding URL and a browser is used to render the page on the web page display screen 20. The web pages displayed contain touch-screen keys that effectively emulate hardware keys.

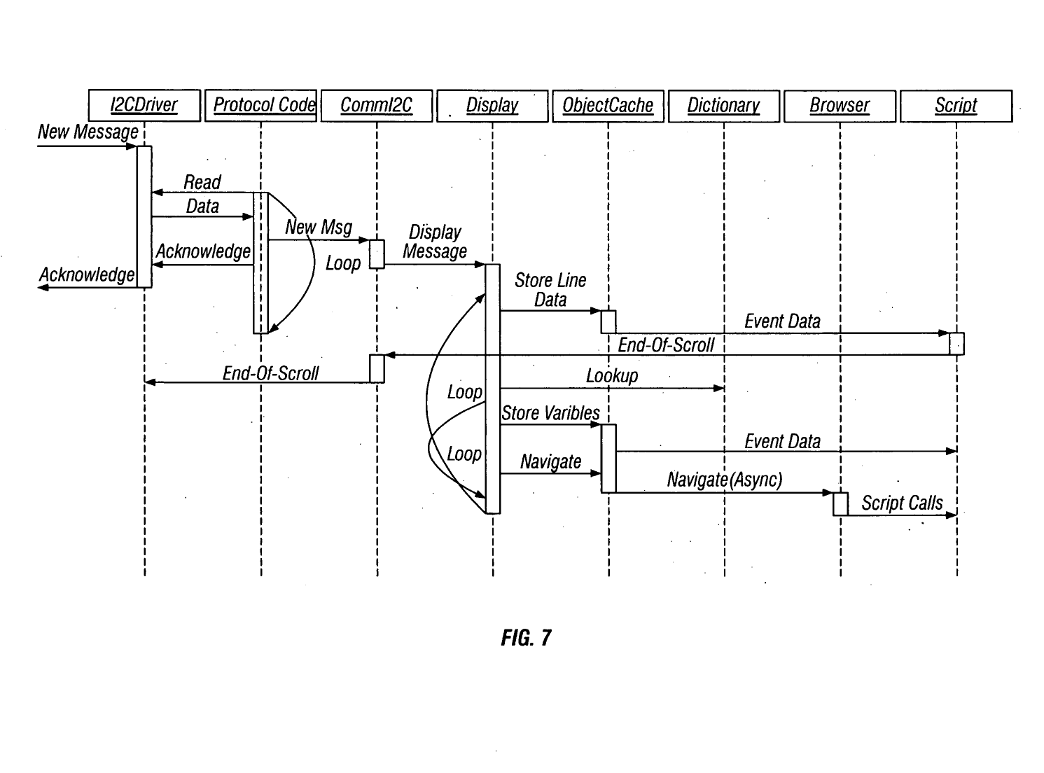

With reference to FIGS. 6A and 6B, in one preferred embodiment of the claimed invention, a dictionary URL approach is used for translating the data messages into web page information. In this manner, data messages are “looked up” in a dictionary data file where they can be redirected to an attractive URL. The embedded processor 30 responds to requests on the I²C bus that were intended for the prior art enhanced player interface (EPI) VF display. The web page display screen 20 is not a passive display device like traditional PC monitors, but rather the display screen 20 must respond to commands with text type responses. These requests include initialization requests, status requests, and display requests. With reference to FIG. 7, as each text data message to be displayed is passed into the embedded processor 30, the processor 30 calls a URL Dictionary to look up a URL with which to replace the text data message. Once the substitution is complete, the embedded processor 30 instructs the web page display screen 20 to present (or navigate to) the appropriate web page.

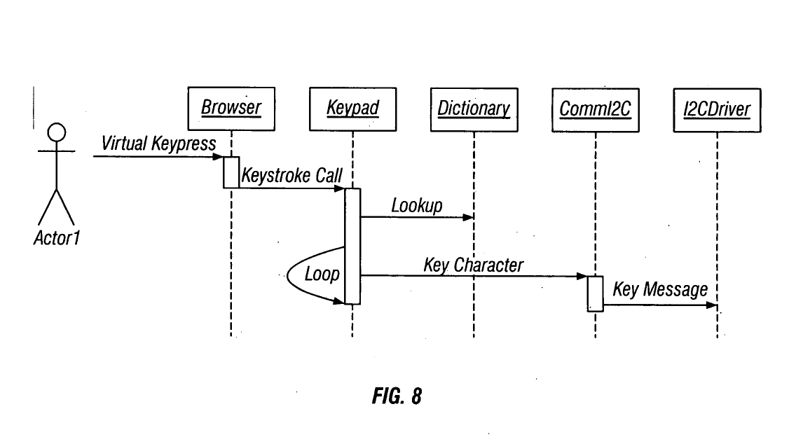

Accordingly, with reference to FIG. 8, a URL Dictionary component is used to map a text string, sent from the embedded processor 30 and intended for the display on the 2×20 VF display, to a URL that can be used to display a much more visually enhanced graphical representation of the same message. Thus, the URL Dictionary component contains a listing of the possible text messages to be supported that could be sent from the embedded processor 30, and a mapping to a set of the desired eye-catching, web content to be displayed on the web page display screen 20. In this event that a message is not in the URL Dictionary, such a message is mapping to a page that substitutes for the 2-line mode.

In the preferred embodiments described above, the embedded processor 30 of the embedded additional user interface 10 reads incoming I²C data messages, translates the I²C data messages into a web authoring language (e.g., HTML, DHTML, XML, MACROMEDIA FLASH), and maps the newly translated web page data message to the web page display screen 20. Additionally, the embedded additional user interface 10 can also read incoming data messages that are already in a web authoring language (e.g., HTML, DHTML, XML, MACROMEDIA FLASH), and map this web page data to the web page display screen 20. Further, and highly advantageously, a preferred embodiment of the claimed invention also allows casinos that are using the embedded additional user interface 10 to design and use their own content, thereby giving the casinos the ability to decide what the web page presented on the web page display screen 20 of the user interface 10 will look like.

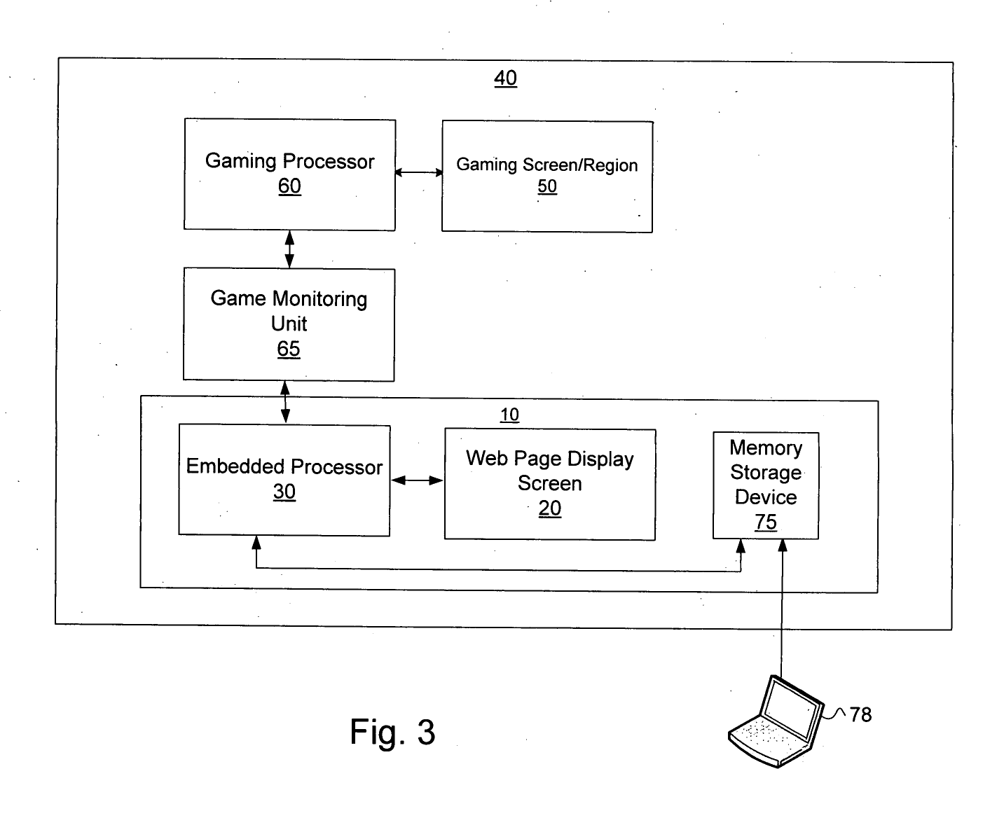

Referring now to FIG. 3, in this preferred embodiment, content may be locally downloaded. Specifically, in one preferred embodiment, the content is updated through a physical USB (or other connection) that is used to download the new content. In one preferred embodiment, the data on the COMPACT FLASH card 75 can be accessed by connecting a separate computer 78 to the network adapter port of the embedded additional user interface 10. This embodiment allows updating the contents of the operating system, changing the operating system itself, and receiving data from the Compact Flash card 75. Physical removal of the COMPACT FLASH card 75 is also still be an option for update and inspection of files on the embedded additional user interface 10.

In one preferred embodiment, a portable computer is used store and publish data content to the COMPACT FLASH card 75 on the embedded additional user interface 10, as well as to receiving data from the COMPACT FLASH card 75 on the embedded additional user interface. In this embodiment, all content on the embedded additional user interface 10 is authenticated as if it were a gaming machine.

In another preferred embodiment, a network adapter port is run on the embedded computer board of the user interface 10. This embodiment also includes a boot loader. Further, in this embodiment, the portable computer 78 (described above) includes components for use in uploading data to, and downloading data from, the COMPACT FLASH card 75 on the embedded additional user interface 10. Specifically, the components that run on the portable computer 78 are for moving new data content to the embedded additional user interface 10, and for validation and verification of the data content that is on the embedded additional user interface. Preferably, all data that is used to update the COMPACT FLASH card 75 moves to or from the embedded additional user interface 10 over the single built in network adapter port on the board.

Prior to the advent of the embedded additional user interface 10 of the claimed invention, gaming regulators would have been unwilling to allow casino operators to design their own content. However, due to the cryptographic technology implemented by the embedded processor 30 in the embedded additional user interface 10, a certification process is provided by the claimed invention with sufficient security for gaming regulators to allow casino operators to design their own content. Specifically, in one preferred embodiment, the certification process offered ensures authentication and non-repudiation of the casino operator designed web content. Preferably, in the claimed invention the certification process provided further ensures auditability and traceability. Various cryptographic technologies, such as authentication and non-repudiation (described herein below), are utilized in preferred embodiments of the claimed invention, to provide sufficient security for gaming regulators to allow casino operators to design their own content.

In one preferred embodiment, this certification process is used to certify “signed content” (created by the casino owners) in the same manner that a “signed program” is certified. Preferably, PKI (Public Key Infrastructure) is utilized in the certification process. PKI is a system of digital certificates, Certificate Authorities, and other registration authorities that verify authenticity and validity. In one preferred embodiment, a “new tier” or second PKI is created that is rooted in the primary PKI and that leverages the capabilities of the certificate (e.g., a x509 certificate) that allow for limited access. Thus, this preferred embodiment allows the attributes within the certificate are used to provide “levels” of code access and acceptance in the gaming industry.

In one embodiment, the content is protected by digital signature verification using DSA (Digital Signature Algorithm) or RSA (Rivest-Shamir-Adleman) technology. In this regard, the content is preferably protected using digital signature verification so that any unauthorized changes are easily identifiable. A digital signature is the digital equivalent of a handwritten signature in that it binds an individual's identity to a piece of information. A digital signature scheme typically consists of a signature creation algorithm and an associated verification algorithm. The digital signature creation algorithm is used to produce a digital signature. The digital signature verification algorithm is used to verify that a digital signature is authentic (i.e., that it was indeed created by the specified entity). In another embodiment, the content is protected using other suitable technology.

In one preferred embodiment, a Secure Hash Function-1 (SHA-1) is used to compute a 160-bit hash value from the data content or firmware contents. This 160-bit hash value, which is also called an abbreviated bit string, is then processed to create a signature of the game data using a one-way, private signature key technique, called Digital Signature Algorithm (DSA). The DSA uses a private key of a private key/public key pair, and randomly or pseudo-randomly generated integers, to produce a 320-bit signature of the 160-bit hash value of the data content or firmware contents. This signature is stored in the database in addition to the identification number. In other preferred embodiments, higher level Secure Hash Functions are used, such as SHA-256 or SHA-512.

In another preferred embodiment, the claimed invention utilizes a Message Authentication Code (MAC). A Message Authentication Code is a specific type of message digest in which a secret key is included as part of the fingerprint. Whereas a normal digest consists of a hash (data), the MAC consists of a hash (key+data). Thus, a MAC is a bit string that is a function of both data (either plaintext or ciphertext) and a secret key. A Message Authentication Code is attached to data in order to allow data authentication. Further, a MAC may be used to simultaneously verify both the data integrity and the authenticity of a message. Typically, a Message Authentication Code (MAC) is a one-way hash function that takes as input both a symmetric key and some data. A symmetric-key algorithm is an algorithm for cryptography that uses the same cryptographic key to encrypt and decrypt the message.

A Message Authentication Code can be generated faster than using digital signature verification technology; however, a Message Authentication Code is not as robust as digital signature verification technology. Thus, when speed of processing is critical the use of a Message Authentication Code provides an advantage, because it can be created and stored more rapidly than digital signature verification technology.

In one preferred embodiment, the authentication technique utilized is a BKEY (electronic key) device. A BKEY is an electronic identifier that is tied to a particular individual. In this manner, any adding, accessing, or modification of content that is made using a BKEY for authentication is linked to the specific individual to which that BKEY is associated. Accordingly, an audit trail is thereby established for regulators and/or other entities that require this kind of data or system authentication.

Another preferred embodiment of the verification system utilizes “component bindings” for verification using cryptographic security. In component binding, some components come equipped with unalterable serial numbers. Additionally, components such as web content or the game cabinet may also be given another random identification number by the owner. Other components in the system, such as the CMOS memory in the motherboard, the hard drive, and the non-volatile RAM, are also issued random identification numbers. When all or some of these numbers are secured together collectively in a grouping, this protected grouping is referred to as a “binding.” Each component of the machine contains its portion of the binding.

In one such preferred embodiment, every critical log entry made to the content is signed with a Hashed Message Authorization Code (HMAC) that is based on the entry itself, and on the individual binding codes. In this manner, the security produced by the bindings ensures that log entries that are made cannot be falsified or repudiated.

After the critical gaming and/or system components are selected, given individual identifiers, and combined into a protected grouping that is secured using the component “bindings,” any changes to those components will then be detected, authorized, and logged. For example, content within the binding is digitally signed (SHA-1 or better) using the key derived from the bindings. This signature is verified whenever an entry is made to a component within the binding. If the signature is wrong, this security violation and the violator are noted, but typically the entry is not prohibited. In other embodiments, the entry may be prohibited as well. Thus, the component binding produces a cryptographic audit trail of the individuals making changes to any of the components within the binding.

Moreover, bindings ensure that the critical components of a gaming machine system, or the content utilized therein, that have been selected to be components within the binding have not been swapped or altered in an unauthorized manner. Preferably, bindings use unique identification numbers that are assigned to vital parts of the gaming platform including, by way of example only, and not by way of limitation, the cabinet, motherboard, specific software, non-volatile RAM card, content (data), and hard drive. These identification numbers combine in a cryptographic manner to form a “binding” that protects and virtually encloses the included components, such that no component within the binding can be modified, removed, or replaced without creating an audit trail and requiring authentication. Thus, for one of these components within the binding to be changed, appropriate authentication is required and a log file entry is made documenting the activity and the identity of the individual making the change. In one preferred embodiment, a specific level of BKEY clearance or classification is required to make specific changes.

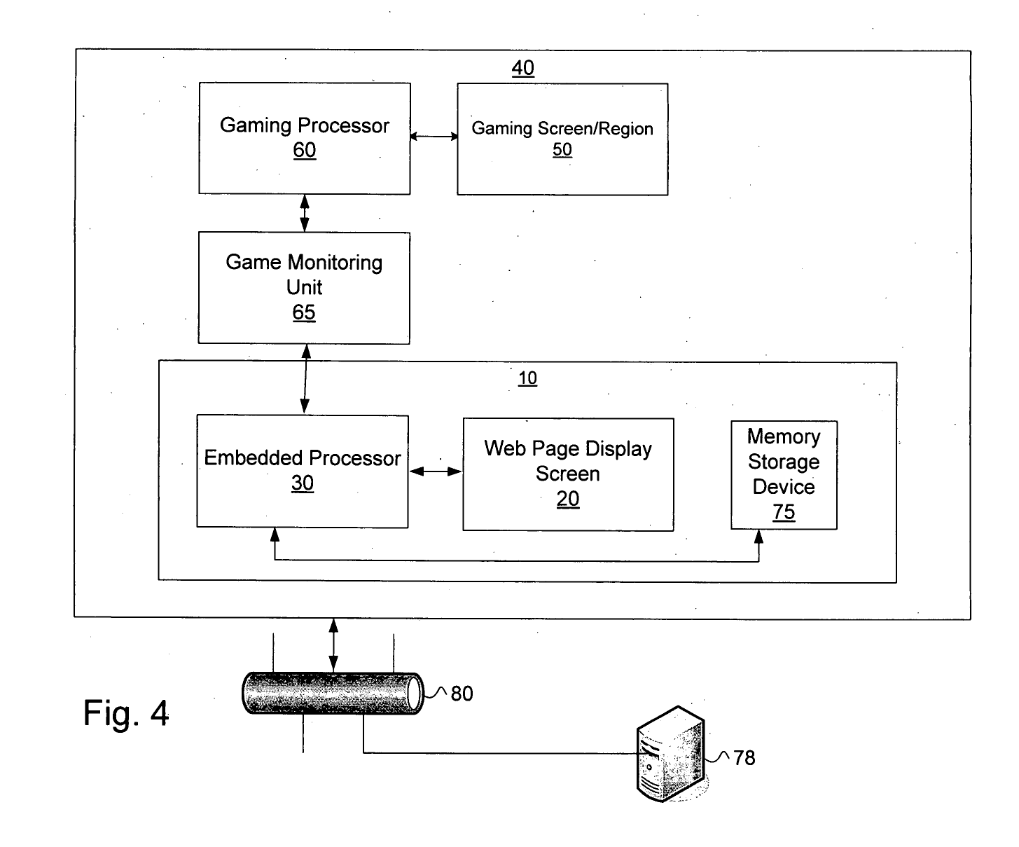

Referring now to FIG. 4, in one preferred embodiment, the embedded additional user interface 10 connects to an Ethernet-networked backbone 80 instead of a local system network. Currently, casino networks are not Ethernet, but rather are smaller, more simplistic local system networks. Thus, in this Ethernet-networked backbone 80 embodiment, the current system network is replaced by an industry standard Ethernet backbone, such as 10/100 base T Ethernet running over Cat 3, 4, 5, 6, or higher. Thus, a standard 10/100 base T Ethernet card is added to the processor in this embodiment. Preferably, the network employs TCP/IP, HTTP, and XML messaging or a variant of XML. Nevertheless any suitable protocol may be used.

Further, in another preferred embodiment, the embedded additional user interface 10 connects to a full featured, back end, download configuration server 90 through the above-described Ethernet-networked backbone 80 as shown in FIG. 4. In such an embodiment, the full-featured server 90 can schedule downloads of content (gaming or otherwise) as well as upload information from the gaming machines 40, such as what options the gaming machines 40 currently possess. Accordingly, in a preferred embodiment, the primary use of the server 90 is as data download and data retrieval server. While this server 90 does upload and download web content style information, it is typically not connected to the World Wide Web. This server 90 must be authenticated (just like a gaming machine) to make the content served to the embedded additional user interface 10 acceptable to the gaming regulators. Preferably, utilization of the Ethernet-networked backbone 80 and the server 90 provides many system benefits, including but not limited to reliability, maintainability, security, content staging, content testing, deployment procedures, and incident recovery. In one embodiment, deliverables also preferably include content templates and guidelines for casino owners and operators to create their own web content for deployment to the web server. In one embodiment, the web server 90 has its content authenticated in the same manner as the embedded additional user interface 10 to allow content to be downloaded to the web page display screen 20.

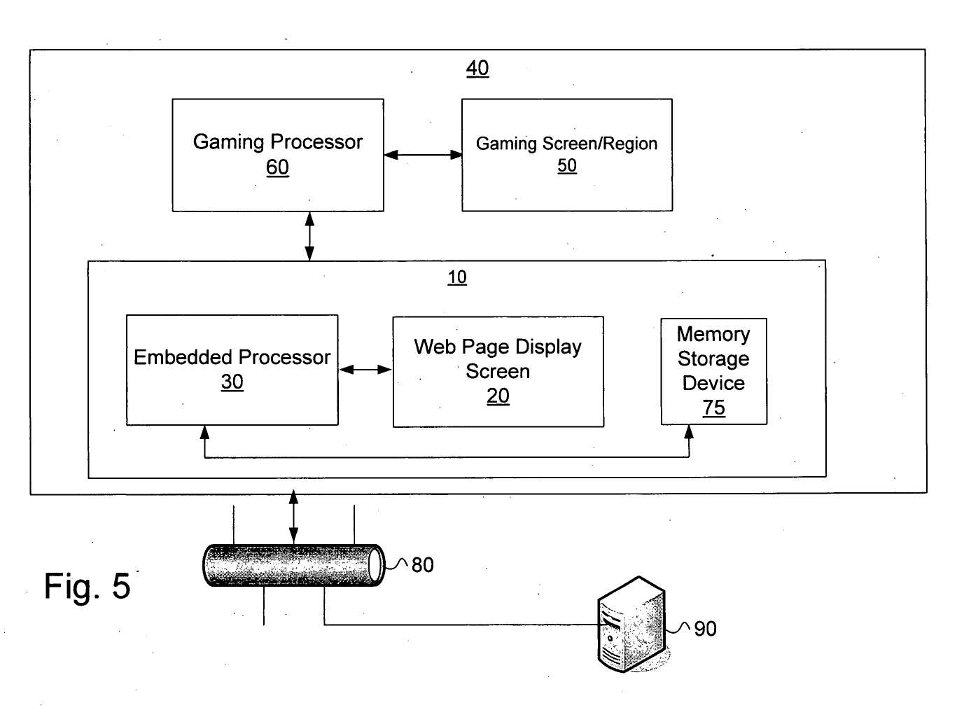

Referring now to FIG. 5, in another preferred embodiment of the claimed invention, the functions previously performed by the gaming monitoring unit 65, as shown in FIGS. 1-4, of the gaming machine 40 are supported by the embedded processor 30 of the embedded additional user interface 10. Otherwise stated, the GMU code is transitioned from the gaming monitoring unit 65 into the embedded processor 30 in the embedded additional user interface 10. Accordingly, such a configuration removes the need for the gaming monitoring unit 65 in the gaming machine 40. This results in a significant reduction in the amount and complexity of the hardware, as well as completing a phased transition of more traditional style gaming machines into more modernized upgraded gaming machines.

Thus, in such a preferred embodiment, the claimed invention is directed towards an embedded additional user interface 10 that is incorporated into a gaming machine 30, the gaming machine in turn including a gaming screen 50 or other appropriate gaming region (e.g., spinning reels), but does not include a gaming monitoring unit 65. Such an embedded additional user interface 10 still includes a web content capable display screen 20 and an embedded processor 30. Once again, the web content capable display screen 20 presents web information to a user via the display screen. The embedded processor 30 preferably utilizes an internal operating system. Furthermore, in this embodiment the embedded processor 30 additionally includes standard gaming monitoring unit functionality (GMU code), since it replaces the gaming monitoring unit 65 in the gaming machine 40. As before, the embedded processor 30 reads incoming data, translates the data into a web protocol (web authoring language), if necessary, and maps the data to the web content capable display screen 20.

In one embodiment, the embedded additional user interface 10, the messages are flashed (e.g., animation, multimedia, and the like) to the player within the web page display screen 20 while the gaming screen 50 is used for game play. These web page style messages can be set at virtually any desired length, format, or style. A message might display, for example, “Welcome to Harrah's Las Vegas! You have 1200 bonus points. Would you like to make a hotel or dinner reservation?” Importantly, while a previous utilized EPI would only been capable of scrolling this message in one-quarter inch (0.25″) tall monochrome text, in contrast, the web page display screen 20 would “flash” this message in bright red, white, black, and green animated format, on six inch (6.0″) by three inch (3.0″) color graphic display. Additionally, in some embodiments, inserting a player identification card into a card reader and/or selecting a player services button activates additional player services functionality.

In one exemplary embodiment of the embedded additional user interface 10 that utilizes a card reader (or other identification technique, such as a player ID code) to recognize a particular player, the web page display screen 20 displays an eye-catching, web page-style message to that player, for example, “Welcome, Mr. Smith!” in response to identifying Mr. Smith. Preferably, the web page display screen 20 also has touch screen capabilities that include, by way of example only, and not by way of limitation, “Beverages,” “Change,” “Services,” “Transactions,” and “Return to Game.” In one embodiment, each of the touch screen icon buttons, when selected, launches a new full screen display within the web page display screen 20 for the player.

For example, in one embodiment, when the “Transactions” touch screen icon button is selected, a new screen is activated that includes the web page style message, “Mr. Smith, Account Balance: Bonus Points=1200, Player Funds=$150, Available Credit=$850, Casino Matching Funds Available=$25,” as well as the “Return to Game” icon button 120. As a further example, when the player selects a “Cashless Withdraw” button in another embodiment, a new screen is activated that includes a touch screen keypad and flashes the question, “How much do you want?” as well as “Enter,” “Clear,” and “Back” buttons. Preferably, this interface also includes an “Information” button that, when selected, launches a new screen within the web page display screen 20 that provides answers to frequently asked questions and other useful information. Moreover, the web page display screen 20 preferably also includes a “History” button that, when selected, launches a new screen within the web page display screen 20 that provides a history log of all transactions and other actions performed on that gaming machine 40.

In accordance with another preferred embodiment, the claimed invention is directed towards a method for increasing user excitement relating to a gaming machine by providing a richer gaming experience via an embedded additional user interface that is incorporated into the gaming machine. The method preferably includes: receiving a serial data message (e.g., an I²C data message) containing enhanced player information over a serial communication bus (e.g., an I²C) bus in the embedded additional user interface 10; translating the data message (using the embedded processor 30) into a web authoring language; and mapping the data message to the web page display screen 20, wherein the display screen presents web page information to a user via the display screen.

The potential advantages of utilizing the embedded additional user interface 10 of the claimed invention are numerous. These potential advantages include, by way of example only, and not by way of limitation: providing animated and/or multimedia web style content; providing fonts and icons which are larger and more aesthetically appealing; providing special services to players, (e.g., multiple languages, assistance for handicapped individuals); facilitating interactive uses of the web page display screen 20; providing the ability to customize the “look and feel” of the web page display screen 20 for players and casino employees; increased player excitement and participation; and simplified replaceability and/or upgradeability from an EPI or other similar non-web page style components.

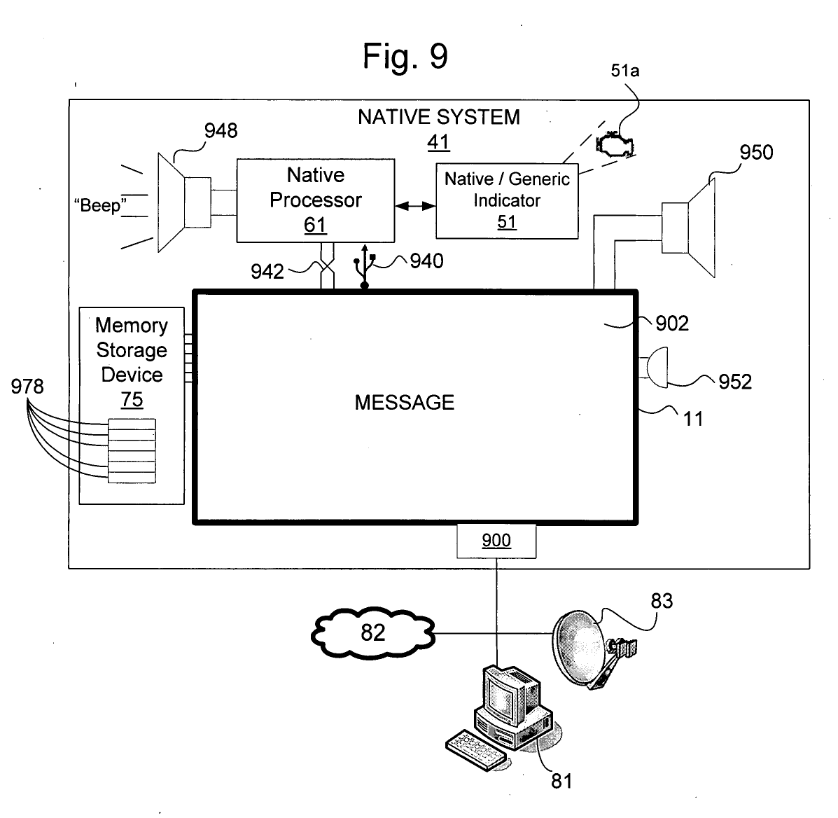

In one embodiment, the invention comprises a self-contained, general purpose user interface. With reference to FIG. 9, a general purpose additional user interface 11 is incorporated into a native system 41 (not necessarily a gaming machine). In one embodiment, the general purpose additional user interface 11 comprises a browser capable display screen 902. A memory storage device 75 stores one or more output data files 978, wherein the display screen 902 presents at least one of the one or more output data files 978 using a browser program. An embedded processor 30 (FIGS. 3-5) employs an internal operating system in the additional user interface 11. The embedded processor communicates with the native system 41, wherein the embedded processor reads context data of the native system, interprets the context data, selects the at data files based on the context data, and presents' the selected one or more output data files on the display;

whereby the display screen increases user interaction by providing an enhanced message regarding a state of the native system.

The embedded additional user interface 11, is similar to the embedded additional user interface 10 described above with respect to FIGS. 3-5. However, the general purpose additional user interface 11 is not limited to use with a gaming machine. The general purpose additional user interface 11 contains hardware and software for realizing a web browser for use as an addition to an electronic device, or other functional device, called a native system 41 herein. The native system 41 is one or more of a wide variety of devices manufactured by one or more entities. The native system 41 is not confined to any particular industry. For example, without limitation, such industries as the automotive, gaming, home appliance, military and manufacturing device industries can benefit from incorporating the additional user interface 11 in native systems 41. In some embodiments, the native system 41 is part of a larger functional system. The additional user interface 11 enhances the native system 41 by adding modem user interface capabilities to the native system 41.

In one embodiment, the additional user interface 11 requires no logic regarding the context of the native system 41, the meaning of the content, or the meanings of user interactions with the content. This makes the additional user interface 11 useful for enhancing a legacy native system 41.

In one embodiment, the additional user interface includes a video display or screen 902 that comprises a touch screen, which in one embodiment, is provided in addition to a visual indicator, light, or screen 51 included with the native system 41. An audio device 950 is provided with the additional user interface 11, which in one embodiment, is in addition to an audio device 948 of the native system 41. A local re-writable data storage device or memory 75 is included. In this embodiment, the data storage device 75 is pre-loaded with user interface content in the form of any combination of the following types, without limitation: a) still graphic images; b) textural information; c) animated graphical data; d) sound information or files; e) multi-media graphic with sound; and f) instructional data in the form of HTML, XML, JavaScript, VBScript, DHTML, and the like.

In one embodiment, the embedded additional user interface 11 uses web browser technology. To provide such functionality, in one embodiment, the embedded additional user interface 10, comprises the equivalent of a small personal computer (PC) in tablet form. In one embodiment, although typically the additional embedded user interface 10 is smaller in dimension, the Gateway® M275 Series by Gateway, Inc. of Irvine, Calif., is a notebook PC that is operable as a Tablet PC and can be used to implement the additional embedded user interface 10. A touch screen 902 is included in such a system. In one embodiment, a processor and memory storage device 75, and other computer electronics are contained in a thin casing behind the touch screen 902. The touch screen 902 obviates the need for a separate keypad or keyboard, if input is required, which can be virtualized on the screen 902. In one embodiment, the Windows® XP® operating system available from Microsoft Corporation of Redmond, Wash. operates the embedded additional user interface 10. In another embodiment, when a smaller interface is required, a personal digital assistant (PDA), such as the Palm Pilot®, available from Palm Computing, Inc. of Santa Clara, Calif. is used instead of a tablet PC. Such PDAs are also capable of executing one or more versions of the Windows® Operating System, including Windows CE® with a web browser built in.

The additional user interface 11 includes at least one bidirectional communications port for communication with the native system 41. Bi-directional communication between the native system 41 and the additional user interface 11 is accomplished using a variety of methods, including, but not limited to, using a connection standardized by the Institute of Electrical and Electronics Engineers (IEEE), such as a USB connection or hub 940, an Ethernet connection, or an IIC connection. For older gaming machines that may not support USB technology, an RS232 (serial asynchronous), or parallel connection 942, with a null modem crossover send/receive wire may be used for bidirectional communications.

In some embodiments, the additional user interface is programmed to communicate with the native system 41 by: a) translating the native communications protocol of the native system 41 to communicate as if the native system 41 was another, or set of, user interface device(s) previously used with the native system; or b) using a new protocol by which the native system 41 is programmed to communicate.

In one embodiment, the native system 41 typically has a processor 61 that provides data to various components of the native system 41. For example, the processor 61 in a native system 41 used by an automobile provides electrical signals to lights on the dashboard to indicate to the driver that a condition is present with respect to operation of the car, such as low oil pressure. Even in modem cars this indicator usually comprises a lighted symbol or text to indicate the condition. Often, the native processor 61 will provide a signal to activate an audible alarm or beep along with the lighted indicator, that is relatively primitive. However, the additional user interface, through the connection 940 or 942, detects the electrical signals, or the processors commands to provide the electrical signals. As a result, the additional user interface 11 causes navigation of a browser executing on the additional user interface 11 to particular information sets, or display pages, stored on its data storage device 75. In one embodiment, this information, once rendered, has components with which the user can interact for sending information back to the functional device. In other embodiments, the information functions to merely provide an enhanced information display for the native system 41.

In one embodiment, the additional user interface 11 includes a sound receiving device 952 (such as a microphone) for detecting voice commands. In this embodiment, the additional user interface 11 includes a USB port, or other type of standardized multi-media port, to which to connect the sound receiving device 952, which is preferably plug-and-play for the Windows® operating system. The voice commands received by the sound receiving device 954 are interpreted by a voice recognition system that is executable on the additional user interface 11. and sent to the functional device in place of commands issues by the user interacting with on-screen interactive components.

Regarding the type of voice recognition system, as recently as in the early 1980s, when main processors in personal computers and consumer electronics were not as fast, it was preferable to use hardware based voice recognition technology. Such hardware based voice recognition systems would typically include accelerated hardware to, among other tasks, sample the analog signals received by a microphone to convert them to digital signals, and to compare the digital signals to digital voice patterns to render text based on the received signals. However, today, typical processors used in personal computers and electronics are about twenty times, or 2000%, faster than the processors used in the 1980s. As a result, the main processor is now used in many, if not most, PC or consumer electronic based voice recognition systems, which are now typically provided in the form of software applications. For example, one such voice recognition system that can be used with the invention is the ViaVoice® personal computer software available from the International Business Machines Corporation of Armonk, N.Y.

In FIG. 9, an example of the kinds of messages and sound that may be presented by the additional user interface 11 in an embodiment used for automobiles. Virtually everybody who operates an automobile at one time or another has been confused by the sometimes indecipherable indicators and sounds produced by and on the dashboard. For example, typically, an indicator such as the engine and break light indicators are used for multiple purposes. Even in the luxury car class, the operator's manual describes multiple uses for various indicators in the dashboard. When one break light is illuminated, and a “beep” noise is presented by the in-dash speaker, that indicates one problem regarding the breaks are indicated. However, when a break light, plus another indicator light (e.g., the check engine indicator light) is illuminated, that indicates another problem condition is occurring.

In one type of car, an operators' manual provides a nested hierarchy of indicator descriptions that depend on the various combinations of indicator lights and audible “beeps.” If a combination of indicators are activated, the operator of the vehicle must retrieve the operator's manual, and match the combination of indicator lights to the problem. Even a call to roadside assistance often causes the customer service representative to perform the same search in the user manual, as there are so many makes and models that the indicator lights are difficult for even such experts to memorize.

With this example, the additional user interface 11 provides a useful solution. The additional user interface 11 is mounted in-dash in the automobile, or as an installed unit mounted to the floorboard of the car, the car's dashboard system, or the one or more of the processors in the car, being the native system 41. As indicated above, the additional user interface 11 contains various multi-media style indicators its memory 75. The additional user interface 11 is plugged into native system 41 through either a customized interface, or in more modern vehicles a standard interface is used, such as a USB connection 940 as described above. Through this connection, software running on the additional user interface 11 monitors the various indicators provided by the native system 41 of the car. If a problem condition occurs, the usual indicators 51 are displayed on the dashboard, for example, the check engine light 51a. The usual innocuous “beep” sound is heard. However, once the indicator signals are detected by the additional user interface 11, the software program executing therein performs a lookup function to determine more precisely what is indicated. The combination of indicators that are provided to the dashboard is read, and a table of indicators is consulted to determine the problem condition that is being indicated, based on the combination of indicators detected. Based on this combination, the additional user interface provides an HTML or other type of message for display on the display screen 902.

In the example provided in FIG. 9, only the check engine light 51a is indicated. Also, a “beep” is provided to the speaker 948 of the native system 41. Further, the additional user interface 11 has looked up in its memory 75 the proper message and sound for presentation on its own screen 902 and speaker 950. Further, in this embodiment and situation, the additional user interface 11 detects that the car's engine is running, and that is matched along with the context data from the native system 41 forwarded by the native processor 61 to illuminate the check engine light 51a. As a result, the additional user interface retrieves and displays a message on screen902, for example:
“The engine check light is on because the key is turned to running position, but the engine is currently not running, Maintenance is not necessarily required at this time. Turn the key to re-start the engine, and the light should go off.”

Further, the same message may be provided in audible form on the speaker 950. In one embodiment, the driver or other operator may provide a voice response for the microphone 952. For example, in the scenario of FIG. 9, the driver may say “Acknowledged” or “Thank you” to indicate to the additional user interface 11 that the message no longer needs to be display in the screen 902. The additional user interface 11 uses it's voice recognition to convert the vice command to text, that can be searched and matched in a table of actions to be performed stored in the memory 75. In this case, the action matched is to clear the screen, and stop further indications of the condition detected.

In some embodiments, a network connection to a local or wide area network is provided. Tablet PCs, and now many PDAs such as the Palm Pilots, that may be used to implement the invention typically contain, or have available, one or more built-in networking connections 900 to the Ethernet network 80, which may either comprise a hard-wired connection or an 802.11x “wi-fi” or wireless connection. In the case of a non-stationary native system 41 to which the additional user interface 11 is attached, the network connection 900 comprises a cellular wireless or mobile IPv6 interface. For stationary native systems, such as the gaming machine 40 described above, although other network typologies may be used, the present wide spread availability of Ethernet technology provides an easy networking solution for the system. Security is provided for wireless systems with one or more of variously known encryption systems, such as, but not limited to, wi-fi protected access (WPA).

The network connection 900 is used to provide connections to other electronic devices, such as servers or other computers 81, to a wide area network 82 such as the Internet, or to a satellite communications link 83 to connect to other devices, computers or networks. In one embodiment, the satellite communications link 83 is especially useful in native systems 41 to link and provide information for vehicle tracking and safety systems, such as the LoJack® system by the LoJack Corporation of Westwood, Mass., or to link vehicle fleets to central dispatch locations.

Those skilled in the art would recognize other applications in which the general purpose user interface 11 can be useful. For example, and not by limitation, the general purpose user interface can be used effectively in the areas of banking, retail, pharmacy, or in any area where the user experience can be enhanced by the provision of additional or more precise information than was provided previously.

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention.

Furthermore, the various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An additional user interface incorporated into a native system, the additional user interface comprising:
a multi-media capable display screen, wherein the display screen presents at least one of one or more output data files; and
an embedded processor that employs an internal operating system and communicates with the native system, wherein the embedded processor reads context data of the native system, interprets the context data, selects the at least one of the output data files based on the context data, and presents the selected one or more output data files on the display;
whereby the display screen increases user interaction by providing an enhanced message regarding a state of the native system.

2. The additional user interface of claim 1, wherein the context data comprises data that was previously used by the native system, wherein the context data is enhanced by the additional user interface.

3. The additional user interface of claim 1, wherein the embedded processor communicates with the native system through an IEEE standard connection.

4. The additional user interface of claim 1, wherein the embedded processor communicates with the native system through connection used by the native system.

5. The additional user interface of claim 1, wherein the browser capable display screen is a color graphic touch screen display.

6. The additional user interface of claim 1, further comprising a sound receiving device.

7. The additional user interface of claim 6, wherein the sound receiving device configured to receive voice commands, the additional user interface further comprising a voice recognition system to interpret the received voice commands.

8. The additional user interface of claim 7, wherein the interpreted voice commands are used to control the additional user interface.

9. The additional user interface of claim 1, further comprising a network connection to connect the additional user interface to a network.

10. An additional user interface for enhancing user interaction with a native system, the additional user interface comprising:
a memory having a plurality of output data files stored in the memory;
a display, wherein the display presents one or more output data files; and
a processor capable of receiving context data from the native system through a connection to the native system, wherein the processor reads the context data received from the native system and matches the context data with the output data files for presentation on the display.

11. The additional user interface of claim 10, wherein the context data includes data previously used by the native system that is enhanced by the additional user interface.

12. The additional user interface of claim 10, wherein at least one of the output data files for presentation is of a type selected from the group consisting of: text files, still graphic image files, animated graphical files, sound files, video files; multi-media graphic with sound files, executable code files, markup language files, instructional data files, and browser files.

13. The additional user interface of claim 10, further comprising an audio device wherein at least one of the output data files for presentation comprises a sound file for presentation on the audio device.

14. The additional user interface of claim 10, further comprising a display program to display the at least one of the one or more output data files.

15. The additional user interface of claim 10, wherein the additional user interface is connected to the native system through a connection that is used by the native system.

16. The additional user interface of claim 10, wherein the additional user interface is connected to the native system through an IEEE standard connection.

17. The additional user interface of claim 10, further comprising a sound receiving device.

18. The additional user interface of claim 17, wherein the sound receiving device is configured to receive voice commands, the additional user interface further comprising a voice recognition system to interpret the received voice commands.

19. The additional user interface of claim 18, wherein the interpreted voice commands are used to control the additional user interface.

20. The additional user interface of claim 10, further comprising a network connection to connect the additional user interface to a network.

21. A method for enhancing user interaction with a native system, the method comprising:
providing an additional user interface having a processor, memory, a plurality of output data files stored in the memory; a display, and a connection capable of receiving context data from the native system;
receiving context data from the native system;
matching the context data with one or more of the output data files; and
presenting the one or more output data files.

22. The method of claim 21, wherein the received context data includes data previously used by the native system that is enhanced by the additional user interface.

23. The method of claim 21, wherein at least one of the output data files presented is of a type selected from the group consisting of: text files; still graphic image files; animated graphical files; sound files; video files; multi-media graphic with sound files; executable code files; markup language files; instructional data files; and browser files.

24. The method of claim 21, wherein at least one of the output data files presented is a sound file, the method further comprising presenting the sound file with an audio device.

25. The method of claim 21, wherein the presenting of the one or more output data files comprises displaying at least one of the one or more output data files on the display using a browser program.

26. The method of claim 21, further comprising connecting the additional user interface to the native system through a connection that is proprietary to the native system.

27. The method of claim 21, further comprising connecting the additional user interface to the native system through an IEEE standard connection.

28. The method of claim 21, further comprising providing a sound receiving device.

29. The method of claim 28, further comprising receiving voice commands and interpreting the received voice commands.

30. The method of claim 29, further comprising controlling the additional user interface based on the interpreted voice commands.

31. The method of claim 21, further comprising connecting the additional user interface to a network.

32. An embedded additional user interface incorporated into a native system, the native system having a native processor, the embedded additional user interface comprising:
a display screen, wherein the display screen presents enhanced information to a user via the display screen; and
an embedded processor that employs an internal operating system and communicates with the native processor, wherein the embedded processor reads incoming data, translates the data into the enhanced information, and maps the data to the display screen;
whereby the display screen increases user interaction by providing an enhanced message regarding a state of the native system.

33. An embedded additional user interface incorporated into a native system, the native system having a native processor, the embedded additional user interface comprising:
a display screen, wherein the display screen presents enhanced information to a user via the display screen; and
an embedded processor that employs an internal operating system and communicates with the native processor, wherein the embedded processor reads incoming data, translates the data into the enhanced information, and maps the data to the display screen;
whereby the display screen increases usability by providing an enhanced message regarding a state of the native system.
